(19) United States
(12) Patent Application Publication
(10) Pub. No.: US 2008/0271615 A1
(43) Pub. Date: Nov. 6, 2008

(54) Method for Forming a Glove with Custom Logo

(76) Inventor: Antonio J. Viveiros, Lincoln, RI (US)

Correspondence Address: ACUSHNET COMPANY, 333 BRIDGE STREET, P. O. BOX 965, FAIRHAVEN, MA, 02719, US

(21) Appl. No.: 11/744,583

(22) Filed: May 4, 2007

(51) Int. Cl. B41C 1/06; A41D 19/00

(52) U.S. Cl. 101/34; 101/483

(57) ABSTRACT

The present invention is generally directed to a method for forming a glove tab with a custom logo, and attaching the glove tab to an existing glove. In a first embodiment, a computer-generated logo is printed onto matte media using an inkjet, laserjet or dot matrix printer, and then the matte media is laminated and cut to fit the shape of a glove tab that is subsequently fastened to an existing glove. In a second embodiment, a computer-generated logo is printed onto glossy media using an inkjet, laserjet or dot matrix printer, and then the glossy media is coated with a liquid adhesive and cut to fit the shape of a glove tab that is subsequently fastened to an existing glove.

### FIELD OF THE INVENTION

The present invention relates to a novel method for forming a glove with custom logo.

### BACKGROUND OF THE INVENTION

Conventional gloves, including golf gloves, may have logos or insignia attached to the gloves to identify the mark of the glove manufacturers, the mark of the manufacturers' customers or any other markings or aesthetic designs. Conventionally, the logo is made from color yarns stitched directly on to the glove or stitched to a cloth backing, which is then stitched to the glove. U.S. Pat. No. 5,708,979 suggests such a method of attachment. This conventional method of attachment requires that the logo be attached to the glove during the manufacturing process of the glove.

This conventional form of attachment offers few opportunities to change the logo to quickly meet ever-changing consumer tastes and market demands. Typically, to change the logo the manufacturer must alter the stitching machine at the manufacturing site and ship the gloves with the new logos to the customer. This process may take significant time to complete, because often the manufacturing site is distant from the customer and the manufacturing site often has other orders waiting to be filled. Furthermore, if the same logo is to be attached to other items, such as golf bags, golf balls, jackets, or shirts, the process of coordinating schedules among the different manufacturers becomes cumbersome.

U.S. Pat. No. 6,159,581 discloses that inkjet printing can be used to produce images on golf gloves. More specifically, an inkjet printer can be used to depict a custom image on a leather-like sheet, which can form the material for the entire back side or palm side of a golf glove. Subsequently, two such leather-like sheets are sewn together to form a golf glove. Although this process allows one to form a custom image, it remains disadvantageous because the image must be printed on one entire side of a golf glove instead of a select portion (e.g. a tab) of the golf glove. Likewise, this process also limits the type of materials that can be used to construct a golf glove because the process discloses the construction of a golf glove from only two pre-existing leather-like sheets of material.

Commonly owned U.S. Pat. No. 6,655,269, incorporated herein by reference in its entirety, discloses a method for pad printing a custom logo onto a pre-existing golf glove's tab. However, as mentioned in commonly owned U.S. Pat. No. 6,736,055, incorporated herein by reference in its entirety, creating the etched plates for the pad printing process can be a time-consuming process involving multiple steps. Commercially-available photopolymer plates all require the use of chemicals and a variety of solvents, including alcohols, for the washing steps. Further, the plates must be created within a finite time prior to printing. Each spot color in the image or selected color space requires a separate plate, and the depth of etch in each plate can be difficult to control. When a new image is desired, the entire process of creating an etched plate for each color must be repeated. Finally, the clean up of plate materials, chemicals, inks, and printing machines, can be cumbersome, and requires strict compliance with a variety of environmental regulations.

Hence, there remains a need for another method of attaching a custom logo to gloves.

### SUMMARY OF THE INVENTION

The present invention is directed towards methods for forming a glove with a logo, comprising the steps of providing a golf glove without a tab; forming a logo in computer memory; printing the logo onto a medium using an inkjet printer, laserjet printer, or dot matrix printer; cutting the medium into the shape of a glove tab; and stitching the glove tab onto the golf glove. The methods can further comprise the step of applying a coating to the medium; or the step of applying a hook-an-loop material to the backside of the medium; or the step of sending a digital image of the logo to a manufacturer.

### BRIEF DESCRIPTION OF THE DRAWINGS

In the accompanying drawings, which form a part of the specification and are to be read in conjunction therewith and in which like reference numerals are used to indicate like parts in the various views:

FIG. 1 is a top view of a glove with a custom logo in accordance to a preferred method of the present invention.

FIG. 2 is a flowchart illustrating a method for the custom fabrication of golf glove tabs.

FIG. 3 is a cross-sectional view of the golf glove tab of FIG. 1.

### DETAILED DESCRIPTION OF THE INVENTION

The present invention is generally directed to a method for forming a glove tab with a custom logo, and attaching the glove tab to an existing glove. In a first embodiment, a computer-generated logo is printed onto matte media using an inkjet, laserjet or dot matrix printer, and then the matte media is laminated and cut to fit the shape of a glove tab that is subsequently fastened to an existing glove. In a second embodiment, a computer-generated logo is printed onto glossy media using an inkjet, laserjet or dot matrix printer, and then the glossy media is coated with a liquid adhesive and cut to fit the shape of a glove tab that is subsequently fastened to an existing glove.

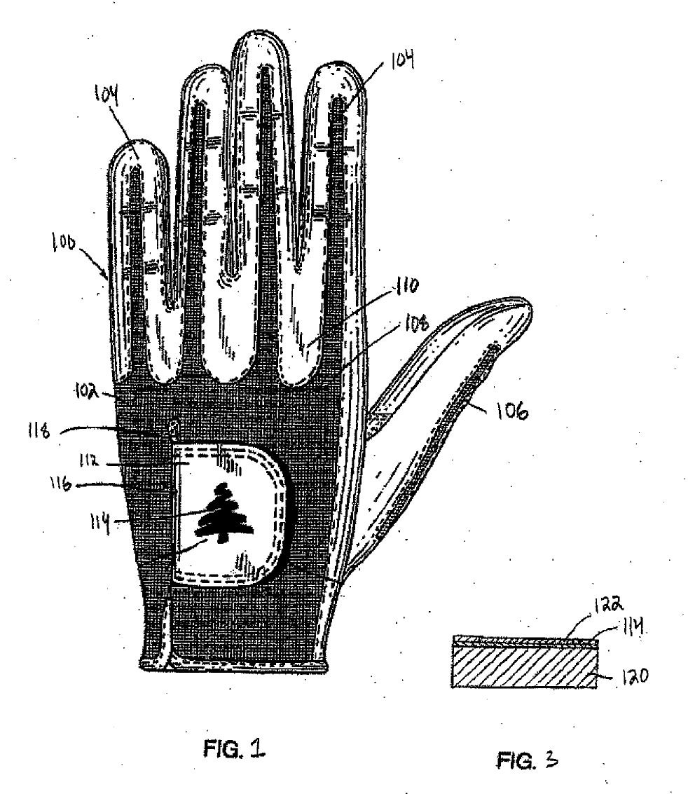

As shown generally in FIG. 1, reference number 100 broadly designates a glove, and more preferably a golf glove, which comprises a back covering portion 102, a plurality of finger casings 104 and a thumb casing 106. Preferably, glove 100 is made from a plurality of materials, including relatively solid materials 108 and mesh materials 110. The preferred solid materials include, but not limited to, leather or synthetic materials, which are known in the art. The leather can be modified to provide a surface appearance having a continuous pattern of smooth grain and discontinuous roughened areas. This modification provides improved grip characteristics under certain playing conditions and improves the ability to accept adhesives. Other suitable relatively solid materials include simulated leather, deerskin, doeskin, steer hide, nylon, vinyl, nylon-acrylic, neoprene, and etc. Suitable mesh materials 110 preferably include woven, non-woven, one-way stretch materials and two-way stretch materials. Examples of one-way stretch materials include the elastic G8™, a two layer satin-backed material available from Avon Tape, Inc., 46 N. Montello Street, Brockton, Mass. Examples of two-way stretch materials include the elastic G6™, a mesh made from about 66% polyamide and 34% rubber also available from Avon Tape.

In accordance with one aspect of the present invention, glove 100 comprises a custom glove tab 112 having a logo 114. Preferably, glove 100, without a glove tab 112, is completed at the manufacturing site. As discussed in greater detail below, a customer provides an image of a logo 114 to the manufacturer, and the manufacturer then prints the logo 114 onto a glove tab 112 and attaches it to glove 100. Glove tab 112 is preferably made from the same relatively solid material described above, because this material presents a relatively smooth surface for attachment. Glove tab 112 may be directly attached at edge 116 to the glove 100 by means of adhesives, stitches, or the like. The underside of glove tab 112 may be attached to the glove 100 by hook-and-loop fastener material such as VELCRO®. Advantageously, a glove tab 112 with hook-and-loop fastener material and slit 118 allows a user to open and close the glove to facilitate hand insertion.

Custom fabrication of a glove tab 112 having a logo 114 is advantageous because it provides customers, such as country clubs, golf courses, and tournament organizers and sponsors, with flexibility to match logo 114 with logos attached to related products such as golf balls, clothing, golf bags, etc. Additionally, the customers may have multiple logos to be attached to the gloves. The present invention allows the customers this flexibility and cost savings over the conventional practice of creating the multiple logos with color yarns and then stitching the logos to the gloves. Logo 114 may comprise a single or multiple alphanumeric characters, symbol(s) or image(s).

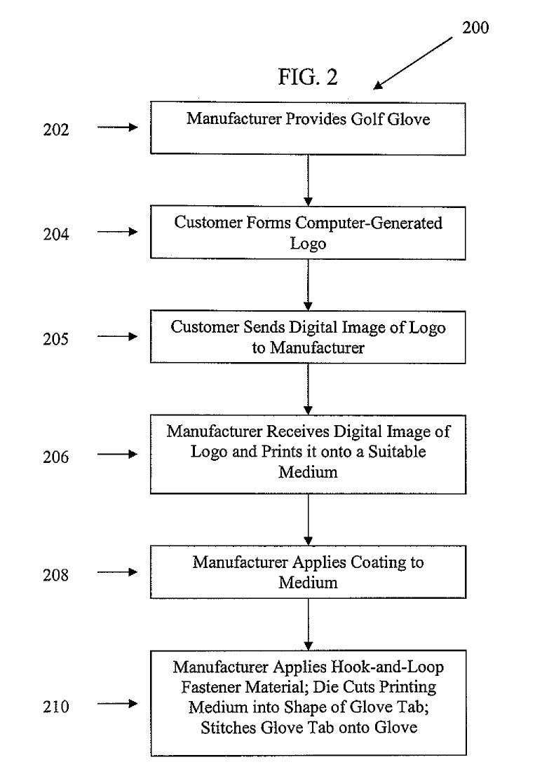

FIG. 2 is a flow diagram showing steps of a method 200, in accordance with the present invention, whereby a custom golf glove tab 112 is fabricated with a logo 114. In step 202, a golf glove 100, without a tab, is provided by a manufacturer. In step 204, a logo 114 is generated by a customer and sent to the manufacturer. Logo 114 of the present invention can be created according to any method. Preferably, logo 114 is created by adding it to computer memory so that logo 114 can be manipulated using various known computer programs such as, but not limited to, “Microsoft Paint®,” “Adobe Photoshop®” and “Adobe Illustrator®.” In particular, a piece of art work provided by a customer can be scanned into computer memory using any of the numerous means of scanning a document into computer memory. Alternatively, the logo or pattern 114 may be created in computer memory by using a program to draw the logo 114 onto the system. Once the logo 114 is in computer memory, the logo 114 is cleaned up, for example, in order to make lines continuous or discontinuous and regions distinct.

In step 205, the customer sends a digital image of logo 114 to the manufacturer in any acceptable digital format (e.g. .tif, .gif, jpg and .pcx formats). The digital image of logo 114 can be sent to the manufacturer via the Internet using a standard or proprietary protocol (e.g., FTP, HTTP, XML) or electronic messaging applications (e.g., e-mail or special-purpose software). Alternatively, a digital image of logo 114 can be saved onto a physical storage medium (e.g., a memory card or recordable CD) and sent to the manufacturer via US postal mail or a private courier such as Federal Express®. By sending a digital image of logo 114 to the manufacturer for further processing, the customer can take advantage of the manufacturer's expertise in the art of golf glove fabrication.

In step 206, a digital image of logo 114 is received by the manufacturer and it is printed onto a suitable printing medium 120 (shown in FIG. 3). More specifically, a digital image of logo 114 is opened using a known computer software program, such as the ones described above, and preferably an inkjet printer is used to print logo 114 onto a suitable inkjet printing medium 120. Any inkjet printer such as, but not limited to, the Canon Pixma iP6000D InkJet Printer, can be used for printing the logo 114. Suitable inkjet printing media 120 should be able to accept color inks that make up the logo. Such suitable inkjet media 120 broadly include matte media, glossy media, iron-on transfer media, etc. The aforementioned process of inkjet printing a golf glove logo 114 represents a significant advance in the art of printing golf glove logos 114 because heretofore logos 114 have been pad printed, a time-consuming process that involves multiple steps. By contrast, inkjet printing allows one to directly print a logo 114 onto any suitable media 120. In alternative embodiments, one can use a laserjet printer or dot matrix printer to print a logo 114 onto a suitable medium 120. The use of a laserjet printer or dot matrix printer also allows one to avoid the difficulties associated with pad printing.

In step 208, a clear or transparent coating 122 (shown in FIG. 3) is applied on top of printing medium 120 bearing logo 114. Suitable coatings 122 include, but are not limited to, a laminate or liquid adhesive, which advantageously protect logos 114 from moisture and other adverse environmental conditions that can negatively affect the image quality of logo 114. The laminate can be a thin layer of plastic film.

In step 210, a hook-and-loop fastener material such as VELCRO® is applied to the backside (not shown) of the printing medium 120. Subsequently, the printing medium 120 is cut, preferably die cut, into the shape of glove tab 112. The resultant glove tab 112 is then stitched onto edge 116 of glove 100. After the glove tab 112 is attached, glove 100 is shipped, from the manufacturing site to the customer. This step 210 of custom fabricating a golf glove tab also represents a significant advance because it allows the entire golf glove tab 112 to be comprised of a logo 114. Moreover, unlike prior art patent '581 (discussed above), logo 114 need not be depicted entirely on one side of the glove 100.

As discussed now in greater detail, two alternate embodiments of the present invention can utilize method 200 to custom fabricate glove tab 112 for glove 100.

In a first embodiment of the present invention, a computer-generated logo 114 is printed onto matte media, which is then laminated and die cut to fit the shape of a glove tab 112 that is subsequently fastened to a glove 100. More specifically, a glove 100, without a tab, is provided in step 202. In step 204, a computer-generated image of logo 114 is created by a customer using computer software, such as Adobe Illustrator® CS 11.0.0 or Adobe Photoshop®. In step 205, a digital image of logo 114 is sent via e-mail, or other means, to the manufacturer.

In step 206, the manufacturer receives the digital image of logo 114 and prints it onto a printing medium 120 using an inkjet printer (e.g., the Canon Pixma iP6000D® Inkjet Printer), laserjet printer or dot matrix printer. Preferably, the printing medium 120 is a vinyl matte self-adhesive medium. More particularly, the printing medium 120 is a 30 micron leather embossed polypropylene film with high performance acrylic adhesive with a release liner.

In step 208, a coating 112, in particular a laminate, is applied by feeding the printing medium 120 through a laminate machine at 175° F. at a speed of 6 feet per minute.

In step 210, a hook-and-loop fastener material such as VELCRO® is applied to the backside of the printing medium 120. Subsequently, the printing medium 120 is die cut into the shape of glove tab 112. The resultant glove tab 112 is then stitched onto edge 116, and glove 100 is shipped from the manufacturing site to the customer.

In a second embodiment of the present invention, a computer-generated logo 114 is printed onto glossy media, which is then coated with a liquid adhesive and die cut to fit the shape of a glove tab 112 that is subsequently fastened to a glove 100. More specifically, a glove 100, without a tab, is provided in step 202. In step 204, a computer-generated image of logo 114 is created by a customer using computer software computer software, such as Adobe Illustrator® CS 11.0.0 or Adobe Photoshop®. In step 205, a digital image of logo 114 is sent via e-mail, or other means, to the manufacturer.

In step 206, the manufacturer receives the digital image of logo 114 and prints it onto a printing medium 120 using an inkjet printer (e.g., the Canon Pixma iP6000D® Inkjet Printer), laserjet printer or dot matrix printer. Preferably, the inkjet printing medium 120 is a Liquid Lens® glossy self-adhesive medium.

In step 208, a coating 112, in particular a liquid adhesive such as Dymax® liquid adhesive item #4-20650 is applied by feeding the printing medium 120 through an applicator machine and UV curing machine.

In step 210, a hook-and-loop fastener material such as VELCRO® is applied to the backside of the inkjet printing medium 120. Subsequently, the printing medium 120 is die cut into the shape of glove tab 112. The resultant glove tab 112 is then stitched onto edge 116, and glove 100 is shipped from the manufacturing site to the customer.

In one aspect of the second embodiment, instead of die cutting the printing medium 120 in step 210, between steps 206 and 208, a plotter cutting machine is used to cut the printing medium 120 into the shape of a glove tab.

In addition to the custom fabrication of glove tabs, as discussed above in the first and second embodiments, method 200 can be adapted for additional means of forming custom logos. For instance, method 200 can be adapted for the process of heat transferring a custom logo 114 onto multiple locations of golf glove 100. The custom logo 114 is printed onto an printing medium 120 (e.g., Hewlett-Packard® iron-on transfer medium), which is then manually cut or cut by an automated plotted such as, but not limited to, a Sumac S Class T-Series plotter. Subsequently, the resultant logo 114 is heat transferred to glove 100 by any means known in the art. For instance, a Sal-Bee® Heat Seal machine model #PK500TB can be used to heat transfer logo 114 by applying pressure (80 psi) and heat (250° F.) three times for a duration of ten seconds each time.

Thus, while it is apparent that the illustrative embodiments of the invention disclosed herein fulfill the objectives of the present invention, it is appreciated that numerous modifications and other embodiments may be devised by those skilled in the art. Additionally, feature(s) and/or element(s) from any embodiment may be used singly or in combination with feature(s) and/or element(s) from other embodiments). Therefore, it will be understood that the appended claims are intended to cover all such modifications and embodiments, which would come within the spirit and scope of the present invention.

1. A method for forming a glove with a logo, comprising the steps of
a. providing a golf glove without a tab;
b. forming a logo in computer memory;
c. printing the logo onto a medium using an inkjet printer, laserjet printer, or dot matrix printer;
d. cutting the medium into the shape of a glove tab; and
e. stitching the glove tab onto the golf glove.

2. The method claim 1 further comprising, between steps c) and d), the step of applying a coating to the medium.

3. The method of claim 1 further comprising, between steps c) and d), the step of applying a hook-an-loop material to the backside of the medium.

4. The method of claim 1 further comprising, between steps b) and c), the step of sending a digital image of the logo to a manufacturer.

5. The method of claim 1 wherein the medium is a matte self-adhesive medium.

6. The method of claim 1 wherein the medium is a glossy self-adhesive medium.

7. The method of claim 2 wherein the coating is a laminate.

8. The method of claim 2 wherein the coating is a liquid adhesive.

9. The method of claim 1 wherein step d) comprises die cutting the medium.
